(19) United States
(12) Patent Application Publication
(10) Pub. No.: US 2026/0152159 A1
(43) Pub. Date: Jun. 4, 2026

(54) BRAKE SYSTEM, VEHICLE COMPRISING SUCH A BRAKE SYSTEM, AND METHOD FOR CONTROLLING BRAKES OF SUCH A VEHICLE

(71) Applicant: Volvo Truck Corporation, Goteborg (SE)

(72) Inventors: Lionel ABRAHAM, Orlienas (FR); Vinay TALANKI K S, Bangalore (IN)

(21) Appl. No.: 18/966,272

(22) Filed: Dec. 3, 2024

(51) Int. Cl. B60T 13/38; B60D 1/62; B60T 8/17; B60T 13/68

(52) U.S. Cl. CPC B60T 13/385; B60D 1/62; B60T 8/1708; B60T 13/683

(57) ABSTRACT

A brake system includes an air production module, a trailer control module, a park brakes relay valve and a supply coupling head for supplying air under pressure to brakes of a trailer. A trailer brakes relay valve is permanently supplied with air under pressure and controls supply of air under pressure to the supply coupling head. The trailer brakes relay valve has two control input ports. When control air is applied to either one or both of the control input ports of the trailer brakes relay valve, the trailer brakes relay valve supplies air under pressure to the supply coupling head. When no control air is applied on both of the control ports of the trailer brakes relay valve, the trailer brakes relay valve does not supply air under pressure to the supply coupling head.

### TECHNICAL FIELD

The disclosure relates generally to braking of vehicles. In particular aspects, the disclosure relates to a brake system, to a vehicle comprising such a brake system and to a method for controlling brakes of such a vehicle. The disclosure can be applied to heavy-duty vehicles, such as trucks, buses and construction equipment, among other vehicle types. Although the disclosure may be described with respect to a particular vehicle, the disclosure is not restricted to any particular vehicle.

### BACKGROUND

In the field of vehicles comprising a tractor and a trailer, care must be taken that, when the vehicle is parked, the trailer is held stationary.

In Europe, in such a parked configuration, park brakes of the trailer may be energized by the tractor. In order to follow Australian Design Regulation for Commercial Vehicles (ADR35-07), when park brakes are applied, no air pressure must be provided to the brake circuit of the trailer via a supply coupling head mounted on the tractor. The approach followed in Europe cannot be implemented.

Similar regulations may apply in some other countries, where the same problem arises.

Therefore, there is a need for a brake system applicable to a vehicle including a tractor and a trailer, according to the Australian ADR35-07 regulation or similar regulations.

### SUMMARY

According to a first aspect of the disclosure, the disclosure relates to a brake system for a vehicle comprising a tractor and a trailer, the brake system including an air production module, a trailer control module, a park brakes relay valve and a supply coupling head for supplying air under pressure to brakes of the trailer, wherein:
a trailer brakes relay valve, interposed between the trailer control module and the supply coupling head and permanently supplied with air under pressure from the trailer control module, controls supply of air under pressure to the supply coupling head;
the trailer brakes relay valve has two control input ports, respectively connected to the trailer control module and to the park brake relay valve;
when control air is applied to either one or both of the control input ports of the trailer brakes relay valve, the trailer brakes relay valve supplies air under pressure to the supply coupling head; and
when no control air is applied on both of the control ports of the trailer brakes relay valve, the trailer brakes relay valve does not supply air under pressure to the supply coupling head.

The first aspect of the disclosure may seek to allow applying the park brakes of the trailer, without a need of air input from the tractor. A technical benefit may include safer operation of the brakes of the trailer, and compliance with the Australian ADR35-07 regulation or similar regulations.

Optionally in some examples, including in at least one preferred example, the brake system further comprises a first power line connecting a power output port of the trailer control module to a power entry port of the trailer brakes relay valve and a second power line connecting a power output port of the trailer brakes relay valve to the supply coupling head. A technical benefit may include efficiently providing air under pressure to the supply coupling head.

Optionally in some examples, including in at least one preferred example, the brake system further comprises a first control line connecting a control input port of the trailer control module to a first control port of the trailer brakes relay valve and a second control line connecting a control input port of the park brakes relay valve to a second control port of the trailer brakes relay valve. A technical benefit may include efficiently controlling the trailer brakes relay valve, from the trailer control module and the park brakes relay valve.

Optionally in some examples, including in at least one preferred example, the brake system further comprises a service brakes control device selectively providing the first control line with control air under pressure. A technical benefit may include using the service brakes control device to control the service brakes of the trailer.

Optionally in some examples, including in at least one preferred example, the brake system further comprises a third control line connecting the service brakes control device to the trailer control module and to the first control line. A technical benefit may include efficiently controlling the trailer brakes relay valve, from the service brakes control device via the third control line.

Optionally in some examples, including in at least one preferred example, the brake system further comprises a park brakes control device selectively providing the brake relay valve and the second control line with control air under pressure. A technical benefit may include using the park brakes control device to control the park brakes of the trailer.

Optionally in some examples, including in at least one preferred example, the brake system further comprises a fourth control line connecting the park brakes control device to the park brakes relay valve and to the second control line. A technical benefit may include efficiently controlling the trailer brakes relay valve, from the service brakes control device via the fourth control line.

Optionally in some examples, including in at least one preferred example, the brake system further comprises a control supply head supplied with air under pressure by the trailer control module, independently of the trailer brakes relay valve. A technical benefit may include using the control coupling head to control the service brakes of the trailer.

Optionally in some examples, including in at least one preferred example, the brake system further comprises a permanent bypass line between an input port of air under pressure of the trailer control module and a control input port of the trailer control module. A technical benefit may include permanently supplying the trailer brakes relay valve with air under pressure from a standard trailer control module, similar to the ones used outside Australia.

According to a second aspect of the disclosure, the disclosure relates to a vehicle comprising a tractor, a trailer and the brake system as described above. The second aspect of the disclosure may seek to provide a safer vehicle. A technical benefit may include efficiently holding the trailer stationary, even when no energy nor air under pressure is provided by the trailer.

According to a third aspect of the disclosure, the disclosure relates to a method for controlling at least park brakes of the trailer of the vehicle of example 10, by providing air under pressure to the brakes of the trailer, comprising:
a) when control air is applied to either one or both of the control ports of the trailer brakes relay valve, air under pressure is provided to the supply coupling head; and
b) when no control air is applied on both of the control ports of the trailer brakes relay valve, no air under pressure is provided to the supply coupling head.

The second aspect of the disclosure may seek to provide a safer way of operating a vehicle comprising a tractor and a trailer. A technical benefit may include efficiently controlling the park brakes of the trailer, in all configuration of use.

Optionally in some examples, including in at least one preferred example, in step a), air is provided to the supply coupling head under a relative pressure comprised between 6.5 and 9 bars. A technical benefit may include that a clear difference is made between steps a) and b).

Optionally in some examples, including in at least one preferred example, in step b), air at a power output port of the trailer brakes relay valve is at a relative pressure below 0.35 bar. A technical benefit may include a clear difference is made between steps a) and b).

Optionally in some examples, including in at least one preferred example, in step b), the supply coupling head is vented to the atmosphere A technical benefit may include that the park brakes cannot be released when the trailer is parked.

Optionally in some examples, including in at least one preferred example, the brake system includes a control coupling head selectively supplied with control air under pressure by the trailer control module, independently of the trailer brakes relay valve and wherein, in step b), the control coupling head is vented to the atmosphere. A technical benefit may include that the service brakes cannot be actuated when the trailer is parked

Optionally in some examples, including in at least one preferred example, in step a), air under pressure is provided by the supply coupling head to the park brakes of the trailer. A technical benefit may include better control of the park brakes of the trailer.

Optionally in some examples, including in at least one preferred example, in step a), air under pressure is provided by the supply coupling head to the service brakes of the trailer. A technical benefit may include a better control of the service brakes of the trailer.

Optionally in some examples, including in at least one preferred example, the trailer carries an air tank and a trailer spring brakes valve and wherein, in step a), air under pressure is provided by the supply coupling head to the air tank via the trailer spring brakes valve. A technical benefit may include a better repartition of a brake circuitry on the trailer.

Optionally in some examples, including in at least one preferred example, when control air under pressure is supplied to the control coupling head, this air controls a service brakes relay valve mounted on the trailer. A technical benefit may include a better control of the service brakes of the trailer.

Optionally in some examples, including in at least one preferred example, the service brakes relay valve feeds a service chamber of a brake of the trailer depending on the control air under pressure received from the control coupling head. A technical benefit may include a better control of the service brakes of the trailer, via the service brakes relay valve.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is an exemplary to view of a vehicle according to an example, this vehicle comprising a brake system according to an example; and

FIG. 2 is an enlarged view of detail II on FIG. 1.

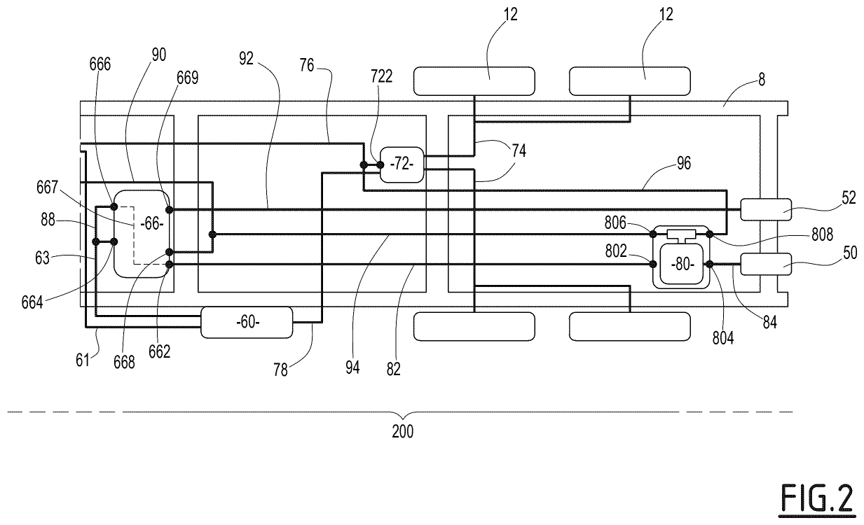

### DETAILED DESCRIPTION

The detailed description set forth below provides information and examples of the disclosed technology with sufficient detail to enable those skilled in the art to practice the disclosure.

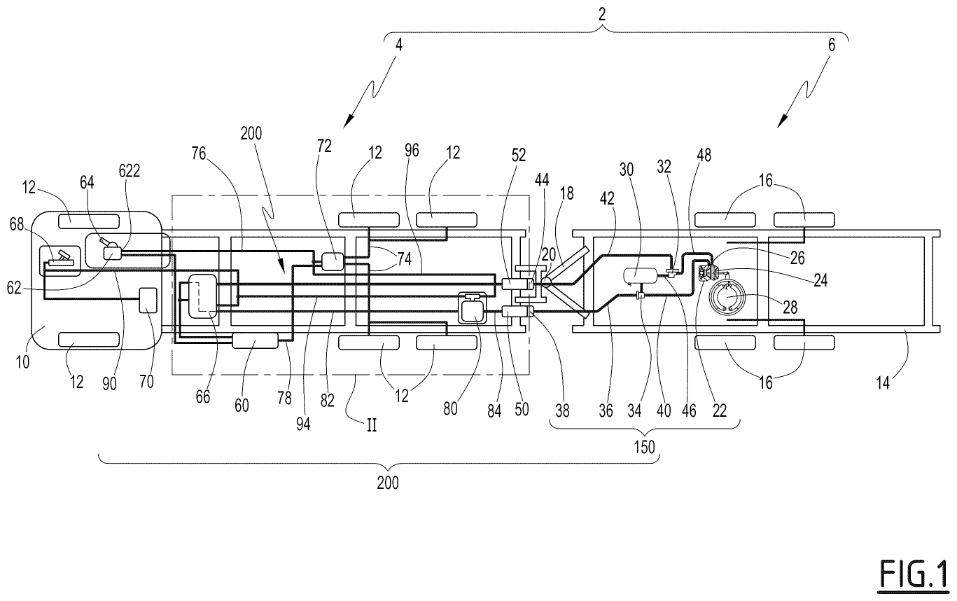

A vehicle 2 according to an example is represented on FIG. 1 and comprises a tractor 4 and a trailer 6. In the non-limiting example of the figures, the vehicle 2 is a truck.

The tractor 4 includes a non-represented power train, which includes an internal combustion engine, an electric motor or an hybrid system. The tractor 4 includes a frame 8, a cabin 10 and several wheels 12.

The trailer 6 includes a frame 14 and several wheels 16.

A trailer drawbar 18 mounted on the front side of the trailer 6 cooperates with a trailer hitch, mounted on the rear side of the tractor 4, in order to attach the trailer 6 to the tractor 4.

Each wheel 12 or 16 is associated with a corresponding combo-brake which can work as a service brake or as a park brake.

As non-limiting example, such a brake is represented with reference 22 on FIG. 1, onboard the trailer 6. It includes a service chamber 24 and a park chamber 26. A piston is moved axially depending on the pressure in the chambers 24 and 26 and controls a drum brake arrangement 28. Advantageously, this structure applies to all non-represented brakes 22.

Advantageously, an air tank 30 is also mounted on the trailer 6, together with a service brakes relay valve 32 and a trailer spring brakes valve 34, which forms a non-return valve.

Advantageously, a first connection line 36 extends between a first coupling head 38 and the trailer spring brakes valve 34. This first connection line allows supplying pressurized air to the air tank 30 and to the park chamber 26. With this respect, a second connection line 40 connects the trailer spring brakes valve 34 to the park chamber 26.

Advantageously, a third connection line 32 connects a second coupling head 44 to a control port of the service brakes relay valve 32. In particular, depending on the pressure applied on a control entry port of the service brakes valve 32, this valve selectively allows air to flow from the air tank 30 into the service chamber 24 of the brake 22.

Air under pressure, which is used in the chambers 24 and 26 of the brakes 22 is provided to the first connection line 36 from the tractor 4, through a supply coupling head 50 con. Control air used for piloting the service brakes relay valve 32 is supplied to the third connection line 42 via a control supply head 52.

The supply coupling head 50 and the control supply head 52 are mounted on the frame 8 of the tractor 4.

Advantageously, the first coupling head 38 of the trailer 6 is configured to be coupled to the supply coupling head 50 of the tractor 4 and the second coupling head 44 of the trailer 6 is configured to be coupled to the control supply head 52 of the tractor 4. When the vehicle 2 is formed of the tractor 4 and the trailer 6, coupling head 38 is coupled to the supply coupling head 50 and coupling head 44 is coupled to the control supply head 52.

46 denotes a fourth connection line between the air tank 30 and the service brakes relay valve 32. 48 denotes a fifth connection line between the service brakes relay valve 32 and the service chamber 24 of the brake 22. The service brakes relay valve 32 is interposed between the fourth and fifth connection lines 46 and 48. This allows the service brakes relay valve 32 to control the flow of air under pressure from air tank 30 to the service chamber 24.

Items 22 to 16 and 30 to 48 belong to a brake circuit 150 of the trailer 6.

In order to follow Australian ADR35-07 regulation, when the park brakes of the vehicle 2 are applied, no air pressure must be provided to the brake circuit 150 of the trailer 6, in particular to the first connection line 36 via the supply coupling head 50. Thus, since the park brake system 150 of the trailer 6 includes several brakes similar to brake 22, which apply by default the park brakes, when they receive no air from the tractor 4, one can be sure that the park brakes of the trailer 6 are applied when they receive no air pressure from the supply coupling head 50.

This function is obtained by adding, amongst others, a trailer brakes relay valve 80 on the tractor 4. This trailer brakes relay valve 80 controls feeding of the supply coupling head 50 with air under pressure, depending on whether the park brakes and the service brakes are used.

On the other hand, when the park brakes must be released and/or when the service brakes must be used, air pressure must be provided to the first coupling head 38 via the connection between the first coupling head 38 and the supply coupling head 50. Moreover, air pressure must be provided to the second coupling head 44 via the connection between the second coupling head 44 and the control coupling head 52.

An air production module or APM 60 is mounted on the frame 8 of the tractor 4 and delivers air under pressure to a park brakes control device 62, in the example formed by a handbrake valve, also called park brake valve, controlled via a handle 64, which is advantageously located in the cabin 10. The air production module 60 also provides air under pressure to a trailer control module or TCM 66, which is also mounted on the frame 8.

61 denotes a pressurized air supply line, i.e. a power line, between the APM 60 and the park brake valve 62. 63 denotes a pressurized air supply line, i.e. a power line, between the APM 60 and the TCM 66.

A service brakes control device 68, in the example made of a pedal, is mounted in the cabin 10 and associated to an electronic braking system or EBS 70.

A park brake relay valve or PBRV 72 is also mounted on the frame 8 of the tractor 4 and allows controlling the non-represented park brakes of the tractor, associated to the wheels 12, and the park brakes of the trailer 6, associated to the wheels 16, represented by the park chamber 26.

Two control lines 74 connect some power output ports of the park brake relay valves 72 to the park brakes of the tractor 4.

On the other hand, another control line 76 connects an output port 622 of the park brake valve 62 to a control input port 722 of the park brake relay valve 72.

A pressurized air supply line, i.e. a power line, 78 connects the air production module 60 to the park brake relay valve 72 and provides air under pressure to this valve.

The trailer brake relay valve or TBRV 80 is also mounted on the frame 8 of the tractor 4. Advantageously, a pressurized air supply line, i.e. a power line, 82 connects a power output port 662 of the trailer control module 66 to a power input port 802 of the trailer brakes relay valve 80, whereas another pressurized air supply line, i.e. a power line, 84 connects a power output port 804 of the trailer brake relay valve 80 to the supply coupling head 50. Thus, the trailer brakes relay valve 80 is interposed between the trailer control module 66 and the supply coupling head 50 and it allows controlling the flow of power air under pressure, from the power output port 662 of the trailer control module 60 to the supply coupling head 50.

664 denotes a power input port of the trailer control module 66 where air under pressure, coming from the air production module 60 through the pressurized air supply line 63, is applied. 666 denotes a control input port of the trailer control module 66 which is connected to the power output port 662 via an internal conduit 667 of the trailer control module 66.

Advantageously, a permanent bypass line 88 connects ports 664 and 666, so that the power output port 662 is permanently supplied with air under pressure from the air production module 60, via the pressurized air supply line 63, the permanent bypass line 88 and the internal conduit 667. The permanent bypass line 88 allows using a standard trailer control module 66, similar to the ones used outside Australia, with standard ports 664 and 666, as a part of the brake system of the example.

Advantageously, a control line 90 connects the pedal 68 to a second control input port 668 of the trailer control module 66. Advantageously, another control line 92 directly connects a control output port 669 of the trailer control module 66 to the control supply head 52. Thus, the supply head 52 is selectively supplied with air under pressure by the trailer control module 66, independently of the trailer brakes relay valve 80.

Control lines 90 and 92 and the trailer control module 66 allow controlling the service brakes relay valve 32 from the pedal 68, through the connection between coupling heads 44 and 52 and through the third connection line 42.

The trailer brakes relay valve 80 includes a first control input port 806 and a second control input port 808.

Another control line 94 extends between the control line 90 and the first control input port 806 of the trailer brakes relay valve 80. Since the connection line 90 is connected to the control input port 668, the control line 94 connects ports 668 and 806. On the other hand, the control line 94 is selectively provided with control air under pressure by the pedal 68, via the control line 90.

Another control line 96 connects the control line 76, thus the control input port 722 of the park brake relay valve 72, to the second control input port 808 of the trailer brakes relay valve 80. On the other hand, park brake relay valve 72 and the control line 96 are selectively provided with control air under pressure by the handbrake valve 62, via the control line 76.

Advantageously,
the control line 94 forms a first control line connecting ports 662 and 806,
the control line 96 forms a second control line connecting ports 722 and 808,
the control line 90 forms a third control line connecting the service brakes control device 68 to the trailer control module 66 and to the first control line 94
the control line 76 forms a fourth control line connecting the park brakes control device 62 to the park brake relay valve 72 and to the second control line 96.

The trailer brakes relay valve 80 is configured so that, when control air is applied to either one of the first and second control entry ports 806 and 808, the trailer brakes relay valve 80 allows air to flow from the power line 82 to the power line 84, i.e. from the trailer control module 66 to the supply coupling head 50. In other words, in this first configuration, the trailer brakes relay valve 80 supplies air under pressure to the supply coupling head 50. On the other hand, the trailer brakes relay valve 80 is also configured so that, when no control air is applied on both control input ports 806 and 808, the trailer brakes relay valve 80 blocks a flow of air between the power line 82 and the power line 84, i.e. between the trailer control module 66 and the supply coupling head 50. In other words, in this second configuration, the trailer brakes relay valve 80 does not supply air under pressure to the supply coupling head 50.

Thus, a brake system 200 is formed on the vehicle 2 by the brake circuit 150 of the trailer 6 and by parts 50 to 96 of the tractor 4. This brake system 200 allows the vehicle 2 to meet Australian ADR35-07 regulation.

Operation of the brake system 200 is as follows:

The trailer control module 66 is permanently supplied with air under pressure from the air production module 60, on its power entry port 664. The trailer brakes relay valve 80 is permanently supplied with air under pressure via the power line 82, because of the permanent bypass line 88 and of the internal conduit 667. The trailer brakes relay valve 80 selectively supplies the supply coupling head 50 with air under pressure received on its power input port 802, depending on whether or not at least one of its control input ports 806 and 808 is supplied with control air coming either from the trailer control module 66 or from the park brake relay valve 72.

On the other hand, the control air supplied to the first and second control input ports 806 and 808 respectively comes from the pedal 68 or from the handbrake valve 62 since the first and second control lines 94 and 96 are respectively connected to the third and fourth control lines 90 and 76.

In particular, when the park brakes must be applied, no control air is applied on the control entry port 722 of the park brakes relay valve 72 via the fourth control line 76. Then, no control air is applied on the second control entry port 808 of the trailer brakes relay valve via the second control line 96. On the other hand, when the park brakes must be released, control air is applied on ports 722 and 808 via the fourth and second control lines 76 and 96.

When the service brakes are actuated, control air is applied on the control input port 668 of the trailer control module 66, via the third control line 90, thus on the first control input port 808 of the trailer brakes relay valve 80, via the first control line 94. When the service brakes are not actuated, no control air is applied on ports 662 and 806 via the third and first control lines 90 and 94.

As soon as control air is applied on at least one of the control input ports 806 and 808, the trailer brakes relay valve 80 is in a first supply or open configuration, where it supplies air under pressure to the supply coupling head 50, from its power output port 804. When no control air is applied on both control input ports 806 and 808, the trailer brakes relay valve 80 is in a second closed configuration, where it blocks air under pressure, received permanently at its power input port 802, and does not supply the supply coupling head 50 with air under pressure.

Thus, the trailer brakes relay valve 80, which is piloted by the service brake control device 68 and by the handbrake valve 62 guarantees that, when the vehicle 2 is parked, the park brakes of the trailer 6 are not supplied with air under pressure, so that there is no risk to release these park brakes.

Advantageously, the trailer spring brakes valve 34 may be configured to vent the second connection line 40 to the atmosphere when no air pressure is present in the first connection line 36. This guarantees that no relative air pressure exist in any park chamber 26 of a brake 22 of the trailer 6.

Advantageously, power air or control air is provided within the brake system 200 under a relative pressure comprised between 6.5 and 9 bars. In particular, in the first configuration of the trailer brakes relay valve 80, power air under pressure is provided to the supply coupling head 50 and/or control air under pressure is provided to the control coupling head 52 under a relative pressure comprised between 6.5 and 9 bars.

Conversely, when no air is provided, air in a part of the brake system 200 is at a relative pressure below 0.35 bar. In particular, in the second configuration of the trailer brakes relay valve 80, air at the power output port 804 of the trailer brakes relay valve 80 is at a relative pressure below 0.35 bar and/or air at the control output port 669 of the trailer control module 66 is at a relative pressure below 0.35 bar.

Advantageously, when the trailer brakes relay valve 80 does not supply air to the supply coupling head 50, this supply coupling is vented to the atmosphere. Advantageously, in the same condition, the control coupling head 52 is also vented to the atmosphere.

Example 1: A brake system 200 for a vehicle 2 comprising a tractor 4 and a trailer 6, the brake system including an air production module 60, a trailer control module 66, a park brakes relay valve 72 and a supply coupling head 50 for supplying air under pressure to brakes 22 of the trailer, wherein:
a trailer brakes relay valve 80, interposed between the trailer control module 66 and the supply coupling head 50 and permanently supplied with air under pressure from the trailer control module 60, controls supply of air under pressure to the supply coupling head 50;
the trailer brakes relay valve 80 has two control input ports 806, 808, respectively connected to the trailer control module 66 and to the park brake relay valve 72;
when control air is applied to either one or both of the control input ports 806, 808 of the trailer brakes relay valve 80, the trailer brakes relay valve supplies air under pressure to the supply coupling head 50; and
when no control air is applied on both of the control ports 806, 808 of the trailer brakes relay valve 80, the trailer brakes relay valve does not supply air under pressure to the supply coupling head 50.

Example 2: The brake system of example 1, further comprising:
a first power line 82 connecting a power output port 662 of the trailer control module 66 to a power entry port 802 of the trailer brakes relay valve 80;
a second power line 84 connecting a power output port 804 of the trailer brakes relay valve 80 to the supply coupling head 50.

Example 3: The brake system of example 1, further comprising:
a first control line 94 connecting a control input port 668 of the trailer control module 66 to a first control port 806 of the trailer brakes relay valve 80;
a second control line 96 connecting a control input port 722 of the park brakes relay valve 72 to a second control port 808 of the trailer brakes relay valve 80.

Example 4: The brake system of example 3, further comprising a service brakes control device 68 selectively providing the first control line 94 with control air under pressure.

Example 5: The brake system of example 4, further comprising a third control line 90 connecting the service brakes control device 68 to the trailer control module 60 and to the first control line 94.

Example 6: The brake system of example 3, further comprising a park brakes control device 62 selectively providing the brake relay valve 72 and the second control line 96 with control air under pressure.

Example 7: The brake system of example 6, further comprising a fourth control line 76 connecting the park brakes control device 62 to the park brakes relay valve 72 and to the second control line 96.

Example 8: The brake system of example 1, further comprising a control supply head 52 supplied with air under pressure by the trailer control module 66, independently of the trailer brakes relay valve 80.

Example 9: The brake system of example 1, further comprising a permanent bypass line 88 between an input port 664 of air under pressure of the trailer control module 66 and a control input port 666 of the trailer control module.

Example 10: A vehicle 2 comprising a tractor 4, a trailer 6 and the brake system 200 according to example 1.

Example 11: A method for controlling at least park brakes of the trailer 6 of the vehicle 2 of example 10, by providing air under pressure to the brakes of the trailer, comprising:
a) when control air is applied to either one or both of the control ports 806, 808 of the trailer brakes relay valve 80, air under pressure is provided to the supply coupling head 50; and
b) when no control air is applied on both of the control ports 806, 808 of the trailer brakes relay valve 80, no air under pressure is provided to the supply coupling head 50.

Example 12: The method of example 11, wherein, in step a), air is provided to the supply coupling head 50 under a relative pressure comprised between 6.5 and 9 bars.

Example 13: The method of example 12, wherein, in step b), air at a power output port 804 of the trailer brakes relay valve 80 is at a relative pressure below 0.35 bar.

Example 14: The method of example 11, wherein, in step b), the supply coupling head 50 is vented to the atmosphere.

Example 15: The method of example 11, wherein the brake system 200 includes a control coupling head 52 selectively supplied with control air under pressure by the trailer control module 60, independently of the trailer brakes relay valve 80 and wherein, in step b), the control coupling head 52 is vented to the atmosphere.

Example 16: The method of example 11, wherein, in step a), air under pressure is provided by the supply coupling head 50 to the park brakes of the trailer.

Example 17: The method of example 11, wherein, in step a), air under pressure is provided by the supply coupling head 50 to the service brakes of the trailer.

Example 18: The method of example 11, wherein the trailer 6 carries an air tank 30 and a trailer spring brakes valve 34 and wherein, in step a), air under pressure is provided by the supply coupling head 50 to the air tank via the trailer spring brakes valve.

Example 19: The method of example 15, wherein, when control air under pressure is supplied to the control coupling head 52, this air controls a service brakes relay valve 32 mounted on the trailer 6.

Example 20: The method of example 19, wherein the service brakes relay valve 32 feeds a service chamber 24 of a brake 22 of the trailer depending on the control air under pressure received from the control coupling head 52.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A brake system for a vehicle comprising a tractor and a trailer, the brake system including an air production module, a trailer control module, a park brakes relay valve and a supply coupling head for supplying air under pressure to brakes of the trailer, wherein:
a trailer brakes relay valve, interposed between the trailer control module and the supply coupling head and permanently supplied with air under pressure from the trailer control module, controls supply of air under pressure to the supply coupling head;
the trailer brakes relay valve has two control input ports, respectively connected to the trailer control module and to the park brake relay valve;
when control air is applied to either one or both of the control input ports of the trailer brakes relay valve, the trailer brakes relay valve supplies air under pressure to the supply coupling head; and
when no control air is applied on both of the control ports of the trailer brakes relay valve, the trailer brakes relay valve does not supply air under pressure to the supply coupling head.

2. The brake system of claim 1, further comprising:
a first power line connecting a power output port of the trailer control module to a power entry port of the trailer brakes relay valve; and
a second power line connecting a power output port of the trailer brakes relay valve to the supply coupling head.

3. The brake system of claim 1, further comprising:
a first control line connecting a control input port of the trailer control module to a first control port of the trailer brakes relay valve; and
a second control line connecting a control input port of the park brakes relay valve to a second control port of the trailer brakes relay valve.

4. The brake system of claim 3, further comprising a service brakes control device selectively providing the first control line with control air under pressure.

5. The brake system of claim 4, further comprising a third control line connecting the service brakes control device to the trailer control module and to the first control line.

6. The brake system of claim 3, further comprising a park brakes control device selectively providing the brake relay valve and the second control line with control air under pressure.

7. The brake system of claim 6, further comprising a fourth control line connecting the park brakes control device to the park brakes relay valve and to the second control line.

8. The brake system of claim 1, further comprising a control supply head supplied with air under pressure by the trailer control module, independently of the trailer brakes relay valve.

9. The brake system of claim 1, further comprising a permanent bypass line between an input port of air under pressure of the trailer control module and a control input port of the trailer control module.

10. A vehicle comprising a tractor, a trailer and the brake system of claim 1.

11. A method for controlling at least park brakes of the trailer of the vehicle of claim 10, by providing air under pressure to the brakes of the trailer, comprising:
a) when control air is applied to either one or both of the control ports of the trailer brakes relay valve, air under pressure is provided to the supply coupling head; and
b) when no control air is applied on both of the control ports of the trailer brakes relay valve, no air under pressure is provided to the supply coupling head.

12. The method of claim 11, wherein, in step a), air is provided to the supply coupling head under a relative pressure comprised between 6.5 and 9 bars.

13. The method of claim 12, wherein, in step b), air at a power output port of the trailer brakes relay valve is at a relative pressure below 0.35 bar.

14. The method of claim 11, wherein, in step b), the supply coupling head is vented to the atmosphere.

15. The method of claim 11, wherein the brake system includes a control coupling head selectively supplied with control air under pressure by the trailer control module, independently of the trailer brakes relay valve and wherein, in step b), the control coupling head is vented to the atmosphere.

16. The method of claim 11, wherein, in step a), air under pressure is provided by the supply coupling head to the park brakes of the trailer.

17. The method of claim 11, wherein, in step a), air under pressure is provided by the supply coupling head to the service brakes of the trailer.

18. The method of claim 11, wherein the trailer carries an air tank and a trailer spring brakes valve and wherein, in step a), air under pressure is provided by the supply coupling head to the air tank via the trailer spring brakes valve.

19. The method of claim 15, wherein, when control air under pressure is supplied to the control coupling head, this air controls a service brakes relay valve mounted on the trailer.

20. The method of claim 19, wherein the service brakes relay valve feeds a service chamber of a brake of the trailer depending on the control air under pressure received from the control coupling head.
